(19) United States
(12) Patent Application Publication
(10) Pub. No.: US 2002/0087621 A1
(43) Pub. Date: Jul. 4, 2002

(54) Method and system to manage internet user navigation data

(76) Inventor: Chris L. Hendriks, Houston, TX (US)

Correspondence Address: Conley, Rose & Tayon, P.O. Box 3267, Houston, TX, 77253-3267, US

(21) Appl. No.: 09/752,058

(22) Filed: Dec. 29, 2000

(51) Int. Cl. G06F 15/16

(52) U.S. Cl. 709/203; 709/219

(57) ABSTRACT

A unique method and system to remotely store and manage a computer user's internet navigation data from any computer in the world having access to the internet. More particularly, the present invention relates to a method and system that allows a user to remotely use and manage navigation data, such as cookies and bookmarks, thereby enhancing navigation of the internet. This is accomplished by storing the data at a secure remote server and using a module coupled to the user's internet browser to redirect requests to access or store the internet navigation data to the remote server instead of the user's local computer memory.

### STATEMENT REGARDING FEDERALLY SPONSORED RESEARCH OR DEVELOPMENT

Not applicable.

### BACKGROUND OF THE INVENTION

1. Field of the Invention

The present invention generally relates to a method and system to remotely store and manage a computer user's internet navigation data. More particularly, the invention relates to a method and system that allows a user to securely use and manage navigation data, such as cookies and bookmarks, from a remote server thereby allowing access from any computer in the world coupled to the internet.

2. Background of the Invention

Computer users are increasingly accessing the internet, for entertainment, informational, and work purposes using a variety of computing devices. Accessing and using the internet is often referred to as “surfing the net/web.” To assist users in surfing the net, various types of information and data (referred to herein as navigation data”) have been developed that generally make navigating the internet more efficient. This navigation data may include information regarding the user's identity, preferences, navigation history and any other information that may uniquely identify or be associated with the user and his/her internet activity. Typically this navigation data is stored locally on the user's computer. Two examples of such navigation data are cookies and bookmarks.

Bookmarks are essentially short cuts that allow a user to quickly access favorite websites. Typically, a user can save the address of a favorite website as a bookmark using their internet browser. The address is generally saved by the browser to the user's computer memory. The next time the user wants to visit that website, the user can simply select the bookmark from the browser and the browser will take the user to the address previously saved. Thus, instead of a user having to remember the addresses of favorite websites, the browser can be used to save the address in the user's computer memory for easy access later. Just as a traditional bookmark is used to save one's place in a book for easy access later, the internet version of a bookmark saves one's place on the internet for easy access later. A bookmark, then, is essentially stored navigation data that allows a user to efficiently return to a favorite website.

Cookies, on the other hand, are blocks of data compiled by the visited website and stored on the user's computer for the purpose of recording unique information about the user. When the user revisits the same site, the website searches the user's computer for the cookie and reads the information previously stored therein. The information gathered may serve several purposes; however, the information is typically used so that the website can establish the identity of the user and cater to his/her preferences. For example, the information might allow the website to offer information or categories of products that are of predetermined interest to the user. At the end of each visit to a website, the cookie is rewritten with new or updated data that was compiled during the user's most recent visit. Cookies, then, are essentially stored navigation data that allows a website to identify a visiting user thereby facilitating a more efficient, user-specific interface and exchange of information between the user and the website.

Both cookies and bookmarks require specific navigation data to be stored on the user's computer. Bookmarks are selectively stored by the user to the computer memory while cookies are stored by the visited websites to the user's computer memory. Sophisticated users can manage and tailor cookies and bookmarks, as well as other navigation data, to greatly increase their efficiency in surfing the internet.

A user's navigation data can, however, create some difficulties. In particular, a user's navigation data can be difficult to manage. With the proliferation of computers and the various uses of the internet, users often access the internet using different computers; for instance, computers at work, computers at home, portable computers, desktop computers, handheld devices, and smart phones. Because users often access the internet using different computers, a user's navigation data may become dispersed across the various computers operated by the user thus making access to this data difficult if not impossible. This also creates real difficulties in maintaining consistent navigation data across and among the various computers used. Moreover, if different users access the internet from the same computer, their navigation data will be intermingled on that computer. This can result in a data integrity issue where one user's navigation data overwrites or obscures navigation data for other users. There may also be a security issue when users leave navigation data on a computer they may casually use. Additionally, the storage of navigation data locally occupies storage space in the user's computer memory drive thereby limiting the storage available for other uses.

### BRIEF SUMMARY OF THE INVENTION

In accordance with the present invention, there is provided a novel method and system for storing and managing internet navigation data. In particular, the novel method and system of the present invention allow for navigation data to be selectively stored, accessed and managed at a remote website server instead of the user's local computer memory. This in turn allows access to the user's navigation data from any computer with internet access anywhere in the world. This is accomplished by a local navigation module (“nav module”) coupled to the user's internet browser which selectively redirects requests to access or store navigation data to a remote navigation server (“nav server”). The present invention allows a user to more efficiently manage and use the navigation data regardless what computer is used to access the internet; it enhances security and protects data integrity by allowing users to avoid intermingling navigation data for different users on a common computer; and it preserves local computer memory for other uses.

The inventive method of remotely managing navigation data on the internet generally comprises: logging on to the internet; accessing a remote nav server; and redirecting navigation data to the remote nav server. The method may further comprise selecting whether navigation data is to be managed remotely. Logging on to the internet generally comprises starting an internet browser and starting a nav module coupled to the web browser. Accessing the remote nav server generally comprises logging on to the remote server as a specific user.

The inventive system for remotely managing navigation data generally comprises: a computer having access to the internet via a web browser; a remote nav server accessible via the internet; and a nav module coupled to the web browser selectively redirecting navigation data to the remote nav server. The nav server generally includes remote memory to store the navigation data and interface login protocol which requires each user to login. The nav server typically securely stores the navigation data separately for each user. The nav module may prompt the user to select whether navigation data is to be managed remotely. This prompt may occur each time navigation data is to be accessed. The nav module in conjunction with the web browser typically directs the user to the remote nav server once the internet has been accessed. The nav module may retrieve the remote protocol for redirecting the navigation data from the nav server. The nav module may intercept attempts to read or write navigation data and redirects those attempts to the remote nav server. Alternatively, the nav module may overlay the portion of the web browser responsible for attempts to read and write navigation data. Again alternatively, the nav module may pass to the web browser a remote protocol for redirecting the navigation data to the nav server. The nav module may be incorporated within the web browser. The system may further comprise an internet service provider which in conjunction with the web browser provides internet access, wherein the nav server is incorporated within the internet service provider.

An alternate inventive method for managing navigation data on the internet generally comprises: logging on to the internet; accessing a remote nav server; and downloading navigation data from the remote nav server.

### BRIEF DESCRIPTION OF THE DRAWINGS

The invention can be more fully understood by referencing the accompanying drawings wherein:

FIG. 1 shows a system diagram of a typical user internet connection illustrating the management of navigation data prior to the present invention;

FIG. 2 shows a system diagram of a user internet connection illustrating the management of user navigation data as contemplated by the present invention; and

FIG. 3 shows a flow chart illustrating the method and process of managing navigation data as contemplated by the present invention.

### NOTATION AND NOMENCLATURE

Certain terms are used throughout the following description and claims to refer to particular system components. As one skilled in the art will appreciate, components may be referred to by different names. This document does not intend to distinguish between components that differ in name but not function. In the following discussion and in the claims, the terms “including” and “comprising” are used in an open-ended fashion, and thus should be interpreted to mean “including, but not limited to . . . ”. As used herein, a “computer” includes any computing device such as desktops, laptops, handheld devices, smart phones, and similar devices yet to be named. The term computer is intended to include any and all devices that have a CPU (Central Processing Unit) with memory and software that controls the hardware (i.e., an operating system). The term “memory” includes any data storage device whether persistent (i.e., permanent), such as a hard drive, or non-persistent (i.e., volatile), such as DRAM (Dynamic Random Access Memory). Also, the term “couple” or “couples” is intended to mean either an indirect or direct electrical connection. Thus, if a first device couples to a second device, that connection may be through a direct electrical connection, or through an indirect electrical connection via other devices and connections. Finally, the term “server” includes a single server as well as a plurality of servers coupled together, whether the servers are located together or in disparate physical locations.

### DETAILED DESCRIPTION OF THE DRAWINGS

Referring now to the drawings, wherein like reference characters denote corresponding components or parts:

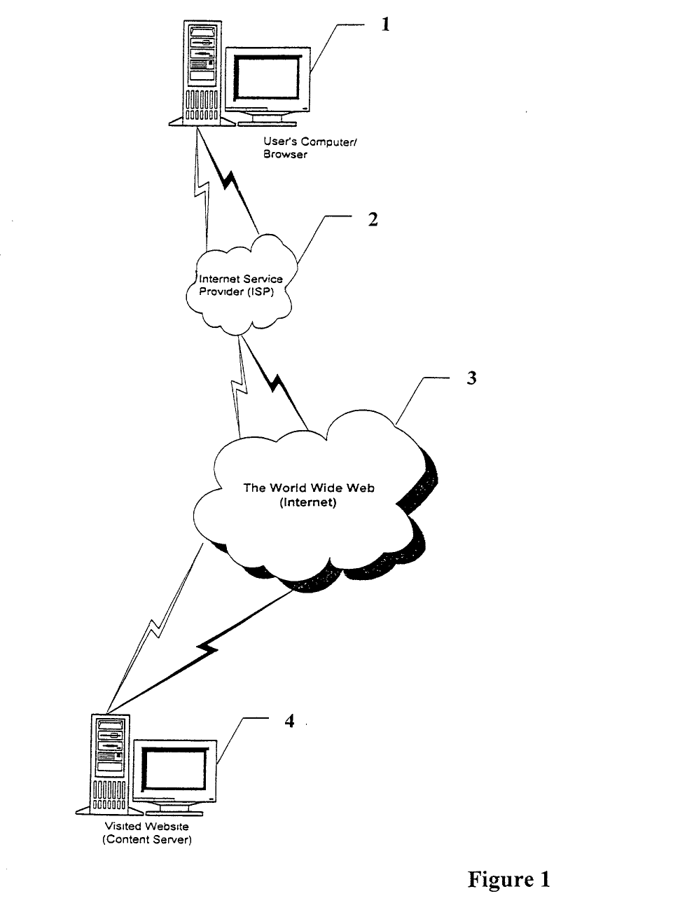

FIG. 1 shows a system diagram of a typical user internet connection illustrating the management of navigation data prior to the present invention. As shown in FIG. 1, a user's computer 1 is typically coupled to an internet service provider (“ISP”) 2 which is in turn coupled to the world wide web or internet 3. A plurality of website content servers are coupled to the internet 3. One such content website 4 is shown in FIG. 1. Although FIG. 1 represents the user computer I with a symbol resembling a traditional desktop computer, any computing device such as laptops, handheld devices, smart phones, etc. may be used to access the internet. Similarly, the website content server 4 may be one or more such computing devices, despite the symbol shown in FIG. 1.

Through use of a web browser installed on the user's computer 1, and using the services of an internet service provider 2, the user logs onto the internet 3. Although most web browsers today are the popular software packages Internet Explorer and Netscape Navigator, the web browser may be software or hardware (for instance WebTV), or any combination thereof, that provides a user interface to conveniently interact with the internet 3. The user may enter into the browser the address of a website he/she wants to visit and the browser will generate the necessary request and navigation data to the internet 3 to contact the website 4. This request passes from the user's computer 1 through the ISP 2 and internet 3 to the website 4. The website 4 typically responds by sending homepage information and data back to the user's computer 1, allowing the website's homepage to be displayed via the browser on the user's computer 1. This response passes from the website 4 through the internet 3 and ISP 2 to the user's computer 1. Many websites provide jump sites in the HTML (Hyper Text Markup Language) of the page displayed which provides access to other websites or pages by simply pointing and clicking on the jump site instead of having to manually type in the address of the target website or page in the browser. Selecting different addresses, whether by manual entry in the browser or by clicking on jump sites, allows the user to navigate around the world wide web or internet 3 to connect with various websites 4. This process of selectively accessing various websites is commonly known as surfing the web/net.

To assist in surfing the net, various types of navigation data and methods of managing navigation data have been developed to simplify and streamline the process of accessing websites 4. For example, if a user wants to return to a specific website 4, he/she can record the address of the website as a bookmark. More specifically, in typical browsers the user can select to record the address of the website or page currently being accessed as a bookmark, also sometimes referred to as a favorite or favorite place. When the browser is instructed to bookmark the website 4, the address of the website is saved by the browser to the memory of the user's computer 1. The bookmark function of the browser typically saves the address in the user's computer memory or hard drive for easy access later. Once saved, the user can simply select the saved bookmark from the browser instead of manually typing in the address of a favorite website 4. When the bookmark has been selected, the saved address is used by the browser to generate the appropriate request and data to contact the website 4.

In addition to bookmarks, cookies are another form of useful navigation data. Most websites 4 use cookies to identify visiting users. In particular, each time the user visits such a website 4, the website 4 will attempt to identify the user by checking the user's computer memory for a cookie. A cookie is simply a data file compiled by the visited website and stored on the user's computer 1 for the purpose of recording information about the user. This information may include the identity of the user, selected preferences of the user, user passwords, a history of the user's interaction with the website, etc. If the user has visited the website 4 before, the cookie saved by the website from the user's previous visits will be read and analyzed. The website 4 can use the information found in the cookie to customize its response to the user. For example, the website 4 can verify the user's password or username, display information to the user based on the user's predetermined preferences, etc. At the end of the visit, the website 4 will rewrite the cookie with new or updated data compiled during the user's latest visit. Since the website is writing this data to the user's computer 1, the data passes from the website 4 through the internet 3 and ISP 2 to reach the user's local web browser. Many browsers allow the user to select whether they will accept a cookie from the visited websites. If accepted, the browser directs the cookie to be saved in the user's computer memory, typically the hard drive.

In summary, then, useful navigation data such as cookies and bookmarks are often stored to the user's local computer memory. This navigation data is used to inform the requests and responses passing between the user's computer 1 and the content website 4 via the internet 3 and ISP 2. The navigation data allows more efficient and user-specific navigation of the internet by utilizing information such as the user's identity, preferences, navigation history, etc.

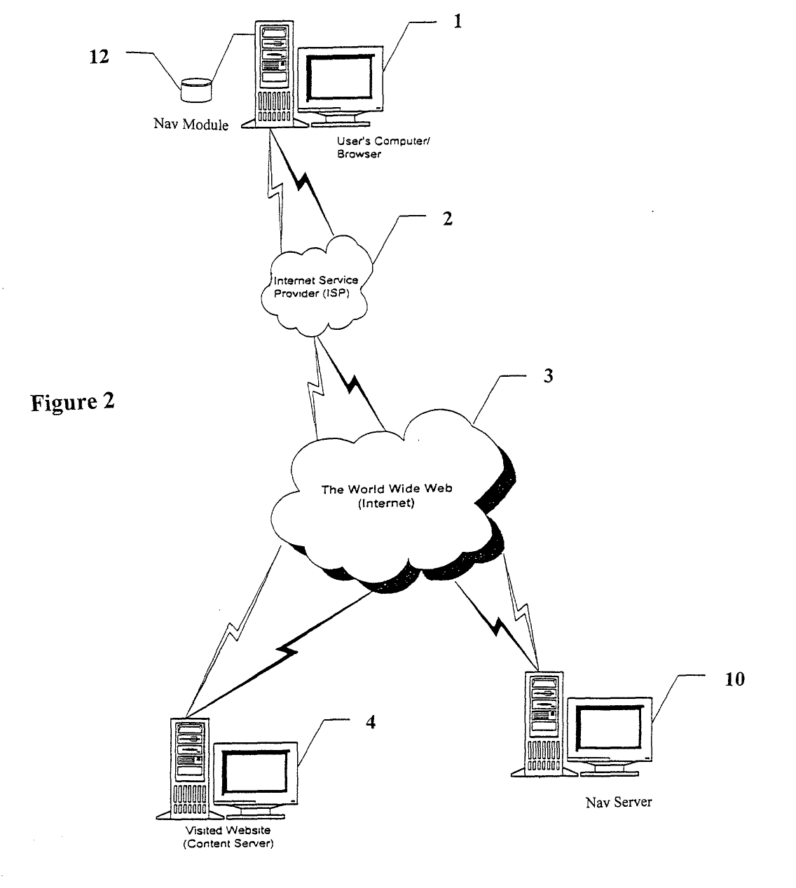

FIG. 2 shows a system diagram of a user internet connection illustrating the management of user navigation data as contemplated by the present invention. In addition to the user's computer 1, ISP 2, internet 3 and content website server 4 interconnected as shown in FIG. 1, FIG. 2 also includes a navigation server (“nav server”) 10 coupled to the internet 3 and navigation module (“nav module”) 12 coupled to the web browser installed on the user's computer 1. The nav server 10 includes system memory remote from the user's computer 1. In accordance with the present invention, the nav server memory is used to store the navigation data, such as cookies and bookmarks, instead of storing this data on the user's local computer memory. This is accomplished by having the nav module 12 redirect attempts to access or store the navigation data to the remote nav server 10 instead of the user's computer 1.

As before, to access the internet 3 the user starts a web browser installed on the user's computer 1, and using the services of an internet services provider 2 logs onto the internet 3. Before surfing the internet 3, however, the user is prompted to select whether navigation data, such as cookies and bookmarks, will be stored and accessed locally on the user's computer memory or remotely on the nav server 10. If the user selects local navigation data, the user will simply proceed to use the web browser to perform the desired navigation of the internet 3 as normal and the navigation data will be handled in the same manner as prior to the invention. If, however, the user selects remote navigation data, the browser will issue the necessary request and data to contact the remote nav server 10. When the nav server's homepage is displayed, the user will be asked to establish his/her identity, this may be accomplished by login using a password or username specific to the individual user but it is not limited to this identification interface. As used herein, login will be used to refer to any identification interface that can be used to uniquely identify individual users (i.e., fingerprint, voice analysis, eye recognition, etc.). Once the user is logged in, the nav server 10 will provide the necessary information to the user's local computer (browser) 1 to allow navigation data to be stored in the memory at the nav server 10 instead of in the local computer memory. Using a login interface, the navigation data is securely and separately stored for each individual user. The nav server 10 may include features to allow the user to view, edit, organize or otherwise manage his/her current navigation data stored in the nav server memory. In addition, the user may choose to download his/her navigation data to the local memory of the computer being used. This would be desirable to setup a new computer (at least new to the user) with the user's navigation data to facilitate efficient internet navigation even if performed without the remote nav server 10.

The user may choose to use the features available at the nav server 10 or simply begin surfing the internet by entering the address of a new website in the browser. From this point on, however, each time the user's internet navigation requires navigation data to be stored or accessed, the navigation data will be at the nav server 10 instead of the user's computer 1. For example, if the user selects to save a particular website as a bookmark, the browser's attempt to save the bookmark to the user's computer memory will be redirected to the remote nav server memory. In addition, if the user wishes to access a previously saved bookmark from his/her browser, the request will be redirected to the nav server 10 and the bookmark will be read from there. Similarly for cookies, when a website attempts to write a cookie to the user's computer 1, the attempt will be redirected to the remote nav server 10 and the cookie will be saved there. In addition, when a website 4 attempts to read a cookie from the user's computer 1, the request will be redirected to the nav server 10. Thus, the navigation data used and created during the user's session on the internet 3 will be on the nav server 10 instead of the user's computer 1.

Two items are used to accomplish the redirection of navigation data from the user's computer: a remote navigation server (“nav server”) 10 and a navigation module (“nav module”) 12. In the current embodiment of the invention as shown in FIG. 2, the remote nav server 10 is a separate website coupled to the internet 3. The remote nav server includes memory to store the user navigation data as well as interface login protocol to ensure that each user's navigation data is stored separately and securely. The remote nav server 10 can be accessed just as any content website coupled to the internet 3. It is contemplated, however, that the nav server 10 and its functions could alternatively be incorporated into the computer systems of the internet service provider 2. Thus, instead of a separate website that would be accessed whenever navigation data is to be stored or retrieved, the navigation data could simply reside in memory at the ISP 2. Given the flexibility of computer servers and systems, the functions of the nav server 10 could simply be programmed into the ISP 2. Since the ISP 2 is also remote from the user's computer 1, the same advantages of remote management of navigation data could be achieved. As used herein, an ISP includes any service or device that provides access to the internet.

The nav module 12 interfaces with the web browser installed in the user's computer 1 to redirect the navigation data and to prompt the user to select local or remote navigation data. In particular, the nav module 12 interfaces with the web browser so that when the user initiates the browser, the user is prompted to select between local or remote navigation data. If local is selected, the nav module 12 need have no further function and control of the navigation data is returned to the web browser for normal handling. If remote navigation data is selected, however, the nav module 12 must direct the browser to issue the necessary request and data to contact the nav server 10. As discussed above, once the user has successfully logged into the nav server 10, the nav server 10 returns the necessary information and data for the remote location of the navigation data. The nav module 12 stores this information for redirection of the navigation data. Using this information, the nav module 12 effectively intercepts attempts by the browser to store or retrieve (write or read) navigation data to the local user computer memory. Instead, the nav module 12 redirects these attempts to the location specified by the remote nav server 10. At the end of the user's internet session, the nav module 12 directs the web browser to logoff of the remote nav server 10 before shutting down the browser.

It is contemplated that the redirection of the navigation data may be realized in at least three ways depending on the structure and makeup of the user's web browser. First, as in the current embodiment described, the nav module 12 may truly intercept the reads and writes issued by the web browser, temporarily storing the navigation data that was to be written to the user's local computer memory, and instead writing the navigation data to the remote nav server 10. Second, the nav module 12 may simply inform the browser of the new remote location to read and write the navigation data. And third, the nav module 12 may include logic which simply overlays that portion of the user's web browser responsible for reading and writing the navigation data. Which solution is used by the nav module 12 necessarily depends on the web browser utilized. Given the flexibility of computer software and hardware, it is also contemplated that the nav module 12 may be incorporated in the web browser, as a function of the web browser.

In the current embodiment of the invention, the nav module 12 is a software module loaded on the user's computer that interfaces with the user's web browser. The nav module 12 may be installed from diskette or downloaded from the internet. In particular, the nav module 12 may be downloaded from the nav server 10. Just as a web browser, however, the nav module 12 may comprise software or hardware. As noted above, variations in the nav module 12 may be required depending on the particular web browser utilized by the user.

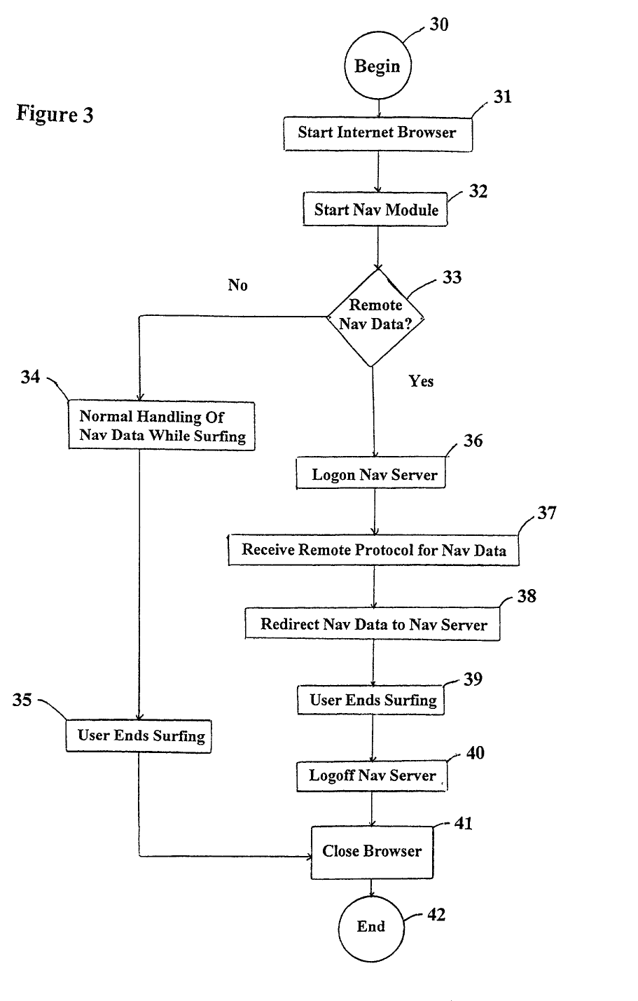

FIG. 3 shows a flow chart illustrating the method and process of managing navigation data as contemplated by the present invention. The process begins, block 30, with the user starting his/her internet browser, block 31. When the browser starts, a navigation module (“nav module”) is also initiated as indicated in block 32. The nav module is coupled to the browser. The nav module in conjunction with the web browser prompts the user to select whether navigation data should be managed locally on the user's computer or remotely at a navigation server (“nav server”) as shown in block 33. If the user selects local navigation data management, the process continues to block 34 and the navigation data will be handled normally by the web browser as the user surfs. In particular, the web browser will simply direct reads and writes of navigation data to the user's local computer memory. When the user chooses to end his/her surfing of the internet, block 35, the browser is closed, block 41, and the process ends, 42.

Alternatively, if the user selects remote navigation data management at block 33, the nav module in conjunction with the browser will direct the user to the nav server to log on, as indicated in block 36. Logging into the nav server allows each user's navigation data to be stored securely and separately. Once the user has logged into the nav server, the nav module will receive the remote protocol for the navigation data (“nav data”), block 37. In particular, the nav module receives the address and formatting needed to read and write navigation data to and from the nav server. Note that to maintain each user's navigation data separately, this protocol will be specific to the individual user. The remote protocol be any current known open standard or be proprietary in nature. Using the remote protocol, the navigation data can now be redirected to the remote nav server while the user is surfing, block 38. When the user ends his/her surfing, block 39, the nav module and browser directs the user to log off the nav server, block 40. Logging off the server can be done either automatically or with manual input from the user. Once the user has logged off the nav server, the internet session can be completed. The browser is closed, block 41, and the process ends, block 42.

It should be noted that at any time the user can choose to continue surfing without remote navigation data by simply returning to the remote nav server and logging off. The user can then continue surfing the internet and the navigation data will be handled normally by the web browser as discussed in reference to block 34 above.

The above discussion is meant to be illustrative of the principles and various embodiments of the present invention. While the invention has been particularly shown and described with respect to specific embodiments thereof, numerous variations and modifications will become apparent to those skilled in the art once the above disclosure is fully appreciated. It is intended that the following claims be interpreted to embrace all such variations and modifications.

What is claimed is:

1. A method of remotely managing navigation data on the internet, comprising:
logging on to the internet;
accessing a remote nav server; and
redirecting navigation data to the remote nav server.

2. The method of claim 1 further comprising selecting whether navigation data is to be managed remotely.

3. The method of claim 1 wherein logging in to the internet comprises:
starting an internet web browser; and
starting a nav module coupled to the web browser.

4. The method of claim 3 wherein the nav module in conjunction with the web browser prompts the user to select whether navigation data is to be managed remotely.

5. The method of claim 3 wherein the nav module in conjunction with the web browser directs the user to the nav server to log in.

6. The method of claim 3 wherein the nav server provides remote protocol for the navigation data to be redirected to the nav server.

7. The method of claim 6 wherein the remote protocol includes the address and formatting for the navigation data to be redirected to the nav server.

8. The method of claim 1 wherein accessing a remote server comprises logging on to the remote server as a specific user.

9. The method of claim 8 wherein the navigation data is separately stored at the nav server for each user.

10. The method of claim 1 wherein the navigation data is securely stored at the nav server.

11. A system for remotely managing navigation data, comprising:
a computer having access to the internet via a web browser;
a remote nav server accessible via the internet; and
a nav module coupled to the web browser selectively redirecting navigation data to the remote nav server.

12. The system of claim 11 wherein the nav server includes remote memory to store the navigation data.

13. The system of claim 12 wherein the nav server securely stores the navigation data.

14. The system of claim 12 wherein the nav server comprises interface login protocol which requires each user to login.

15. The system of claim 14 wherein the nav server separately stores the navigation data for each user.

16. The system of claim 11 further comprising an internet service provide which in conjunction with the web browser provides internet access, wherein the nav server is incorporated within the internet service provider.

17. The system of claim 11 wherein the nav module prompts the user to select whether navigation data is to be managed remotely.

18. The system of claim 11 wherein the nav module prompts the user to select whether navigation data is to be managed remotely each time navigation data is to be accessed.

19. The system of claim 11 wherein the nav module in conjunction with the web browser directs the user to the remote nav server once the internet has been accessed.

20. The system of claim 11 wherein the nav module retrieves the remote protocol for redirecting the navigation data from the nav server.

21. The system of claim 11 wherein the nav module intercepts attempts to read or write navigation data and redirects those attempts to the remote nav server.

22. The system of claim 11 wherein the nav module overlays that portion of the web browser responsible for attempts to read or write navigation data.

23. The system of claim 11 wherein the nav module passes to the web browser a remote protocol for redirecting the navigation data to the nav server.

24. The system of claim 11 wherein the nav module is incorporated within the web browser.

25. A method for managing navigation data on the internet, comprising:
logging on to the internet;
accessing a remote nav server; and
download ing navigation data from the remote nav server.
